(19) United States
(12) Patent Application Publication
(10) Pub. No.: US 2022/0191949 A1
(43) Pub. Date: Jun. 16, 2022

(54) RANDOM ACCESS METHOD AND USER EQUIPMENT

(71) Applicants: SHARP KABUSHIKI KAISHA, Sakai City, Osaka (JP); FG Innovation Company Limited, Tuen Mun, New Territories (JP)

(72) Inventors: CHONGMING ZHANG, Shanghai (CN); RENMAO LIU, Shanghai (CN); SHOHEI YAMADA, Sakai City, Osaka (JP)

(21) Appl. No.: 17/598,458

(22) PCT Filed: Mar. 26, 2020
(86) PCT No.: PCT/CN2020/081377

§ 371 Date: Sep. 27, 2021

(30) Foreign Application Priority Data
Mar. 27, 2019 (CN) 201910240800.3

(51) Int. Cl. H04W 74/08; H04W 72/14

(52) U.S. Cl. CPC H04W 74/0841; H04W 80/02; H04W 72/14; H04W 74/0866

(57) ABSTRACT

A random access method and a user equipment are provided. The random access method includes: transmitting a message A to a base station, the message A includes a preamble and a message A payload; and after completing transmission of the message A, receiving a message B from the base station as a response message to the message A, the preamble is transmitted on a Physical Random Access Channel (PRACH); the message A payload is included in a Medium Access Control (MAC) Protocol Data Unit (PDU), and is transmitted on a Physical Uplink Shared Channel (PUSCH); and obtaining, from a multiplexing and assembly entity, the MAC PDU used for transmission, and storing the MAC PDU in a buffer when determining that a transmission occasion is available for the message A.

### TECHNICAL FIELD

The present invention relates to the technical field of radio communications, and in particular, the present invention relates to a random access method and user equipment for performing the random access method.

### BACKGROUND

In the prior art, in a random access procedure executed by a user equipment (UE), as shown in FIG. 1, a signaling flow includes 4 steps (step 101 to step 104). Therefore, the above random access procedure can generally be referred to as a four-step random access (RA) procedure (hereinafter referred to as a “4-step RA procedure”). As shown in FIG. 1, in step 101, the UE transmits a preamble to a base station. After transmitting the preamble, the UE may receive a Random Access Response (RAR) in step 102 as a response to the transmitted preamble. The UE may transmit a message 3 to the base station in step 103 on an UL resource indicated by an UL grant in the RAR in step 102. After transmitting the message 3, the UE may receive a message 4 in step 104 as a response to the transmitted message 3.

In order to reduce the time required for completing the random access procedure, a two-step random access procedure is currently under discussion. As shown in FIG. 2, a signaling flow includes 2 steps, and this random access procedure can generally be referred to as a two-step random access procedure (hereinafter referred to as a “2-step RA procedure”). As shown in FIG. 2, in step 201, the UE transmits a message A (MSG A) to a base station, wherein the MSG A includes a preamble and a MSG A payload. After transmitting the MSG A, the UE may receive a MSG B in step 202 as a response to the MSG A.

As shown in FIG. 1, in the 4-step RA procedure, when obtaining a UL grant in a received RAR in step 102, the UE obtains, from a multiplexing and assembly entity, a Medium Access Control (MAC) Protocol Data Unit (PDU) used for transmission, and stores the same in a message 3 buffer. In the subsequent step, this MAC PDU serves as an MSG 3, and is transmitted to the base station in step 103.

As shown in FIG. 2, in the 2-step RA procedure, a MAC PDU carrying content similar to or the same as the content of the MSG 3 serves as the MSG A payload, and is transmitted to the base station in step 201. Therefore, the issue regarding how the UE obtains, during the above 2-step RA procedure, the MSG A payload used for a transmission needs to be resolved.

### SUMMARY

In order to resolve at least part of the above issues, provided in the present invention are a random access method and user equipment.

According to a first aspect of the present invention, provided is a random access method performed by a user equipment, the random access method comprising: transmitting a message A to a base station, wherein the message A comprises a preamble and a message A payload; and after completing transmission of the message A, receiving a message B from the base station as a response message to the message A, wherein the preamble is transmitted on a Physical Random Access Channel (PRACH); the message A payload is included in a Medium Access Control (MAC) Protocol Data Unit (PDU), and is transmitted on a Physical Uplink Shared Channel (PUSCH); and obtaining, from a multiplexing and assembly entity, the MAC PDU used for transmission, and storing the MAC PDU in a buffer when determining that a transmission occasion is available for the message A.

In the above random access method, wherein determining that the transmission occasion is available for the message A comprises one of: determining that a PUSCH occasion is available for transmitting the message A payload; determining that a next available PRACH occasion is used for transmitting the preamble; selecting a preamble that is used for a current random access procedure, and the selected preamble selected is associated with the PUSCH occasion.

In the above random access method, wherein obtaining, from the multiplexing and assembly entity, the MAC PDU used for transmission comprises obtaining the MAC PDU if: the UE determines the PUSCH occasion is available for transmitting the message A; and the determined PUSCH occasion is a first PUSCH occasion determined by the UE in the current random access procedure, or the determined PUSCH occasion is used for a new transmission of the message A payload.

In the above random access method, wherein obtaining, from the multiplexing and assembly entity, the MAC PDU used for transmission comprises obtaining the MAC PDU if: the UE determines the next available PRACH occasion; and the determined next available PRACH occasion is a first PRACH occasion determined by the UE in the current random access procedure, or a PUSCH occasion associated with the determined next available PRACH occasion is used for a new transmission of the message A payload.

In the above random access method, wherein obtaining, from the multiplexing and assembly entity, the MAC PDU used for transmission comprises obtaining the MAC PDU if: the UE selects the preamble used for the current random access procedure or the preamble associated with the PUSCH or the PUSCH occasion; and the selected preamble is a first preamble selected in the current random access procedure, or a PUSCH occasion associated with the selected preamble is used for a new transmission of the message A payload.

In the above random access method, wherein obtaining, from the multiplexing and assembly entity, the MAC PDU used for transmission comprises obtaining the MAC PDU if: the UE instructs a physical layer to transmit the selected preamble on the next available PRACH occasion; and the transmitted preamble is used for the current random access procedure, or the transmitted preamble is associated with a PUSCH, or the next available PRACH occasion is associated with a PUSCH.

In the above random access method, further comprising: using the determined PUSCH occasion that is available for as an uplink (UL) grant, and processing the UL grant if the UE determines the PUSCH occasion; using a PUSCH occasion associated with the next available PRACH occasion as an UL grant, and processing the UL grant if the UE determines the next available PRACH occasion; and using the PUSCH occasion associated with the preamble used for the current random access procedure as an UL grant, and processing the UL grant if the UE selects the preamble used for the current random access procedure or the preamble associated with the PUSCH or the PUSCH occasion and the selected preamble is used for the current random access procedure, or the selected preamble is associated with the PUSCH or the PUSCH occasion.

In the above random access method, further comprising instructing the multiplexing and assembly entity to include a Cell Radio Network Temporary Identifier (C-RNTI) MAC Control Element (CE) in a next transmission if the transmission of the message A payload or the transmission of the message A is unrelated to a Common Control Channel (CCCH), or is not performed for a logical channel having a logical channel type of CCCH.

In the above random access method, further comprising: storing the MAC PDU in a message 3 buffer or in a message A buffer; obtaining the MAC PDU from the buffer in which the MAC PDU is stored, and transmitting the obtained MAC PDU when the UE receives an uplink (UL) grant, if: the UL grant is used for the current random access procedure, or if the UL grant is used for the transmission of the message A payload, or the UL grant is related to the current random access procedure, or the UL grant is received in a Random Access Response (RAR).

According to a second aspect of the present invention, provided is a user equipment, comprising: a processor; and a memory, storing instructions, the processor configured to execute the instructions to: transmit a message A to a base station, wherein the message A comprises a preamble and a message A payload; and after completing transmission of the message A, receive a message B from the base station as a response message to the message A, wherein the preamble is transmitted on a Physical Random Access Channel (PRACH); the message A payload is included in a Medium Access Control (MAC) Protocol Data Unit (PDU), and is transmitted on a Physical Uplink Shared Channel (PUSCH); and obtain, from a multiplexing and assembly entity, the MAC PDU used for transmission, and store the MAC PDU in a buffer when determining that a transmission occasion is available for the message A.

### BRIEF DESCRIPTION OF THE DRAWINGS

FIG. 1 is a schematic sequence diagram illustrating a four-step random access procedure;

FIG. 2 is a schematic sequence diagram illustrating a two-step random access procedure;

FIG. 3 is a detailed sequence diagram illustrating a four-step random access procedure;

FIG. 4 is a detailed sequence diagram illustrating a two-step random access procedure according to the present invention;

FIG. 5 is a block diagram illustrating user equipment (UE) according to the present invention;

FIG. 6 is a diagram illustrating a correspondence between a PRACH occasion and a PUSCH occasion according to the present invention; and

FIG. 7 is a diagram illustrating a correspondence between a PUSCH occasion and a preamble according to the present invention.

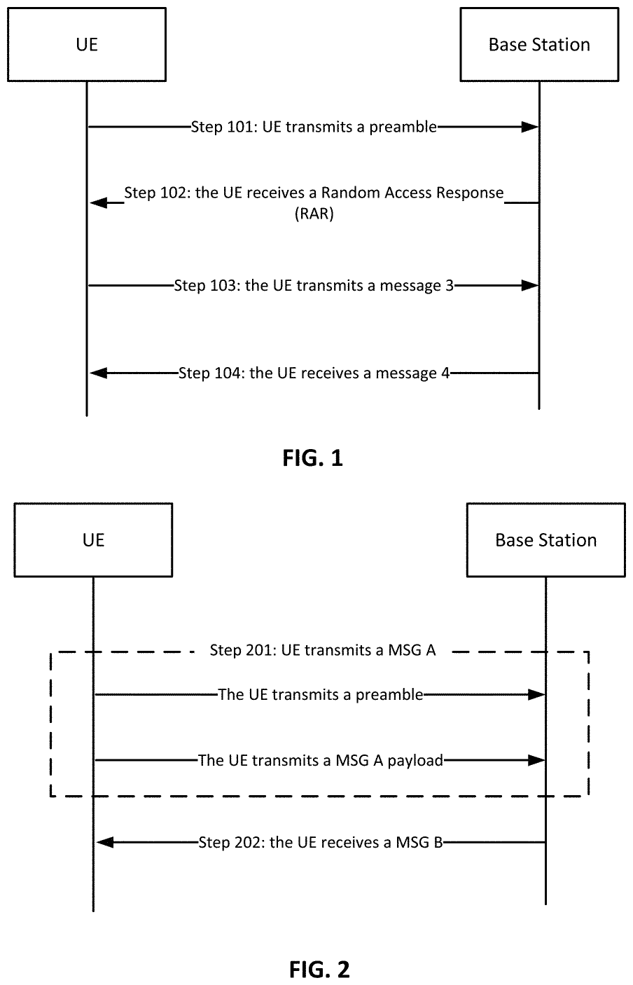

### DETAILED DESCRIPTION

The present invention will be described in detail below with reference to the accompanying drawings and specific embodiments. It should be noted that the present invention should not be limited to the specific embodiments described below. In addition, for the sake of brevity, detailed descriptions of well-known technologies that are not directly associated with the present invention are omitted to prevent confusion in the understanding of the present invention.

Before detailed description, terms mentioned in the present invention are illustrated first as follows. Unless otherwise specified, the terms according to the present invention have the following meanings.

UE: User Equipment

NR: New Radio

LTE: Long Term Evolution

eLTE: Enhanced Long Term Evolution

RRC: Radio Resource Control (layer)

MAC: Medium Access Control (layer)

MAC CE: MAC Control Element

MAC PDU: MAC Protocol Data Unit

MSG 3: Message 3

PRACH: Physical Random Access Channel

PUSCH: Physical Uplink Shared Channel

CCCH: Common Control Channel

UL grant: Uplink grant

C-RNTI: Cell Radio Network Temporary Identifier

RA: Random Access

RAR: Random Access Response

In the following, a plurality of implementation manners according to the present invention are described in detail by using an NR mobile communication system and subsequent evolved versions thereof as an example application environment, and using NR-supporting base stations and UE devices as examples. However, it should be pointed out that the present invention is not limited to the following implementation manners, but can be applied to more other radio communication systems such as eLTE communication systems, and can also be applied to other base stations and UE devices such as eLTE-supporting base stations and UE devices.

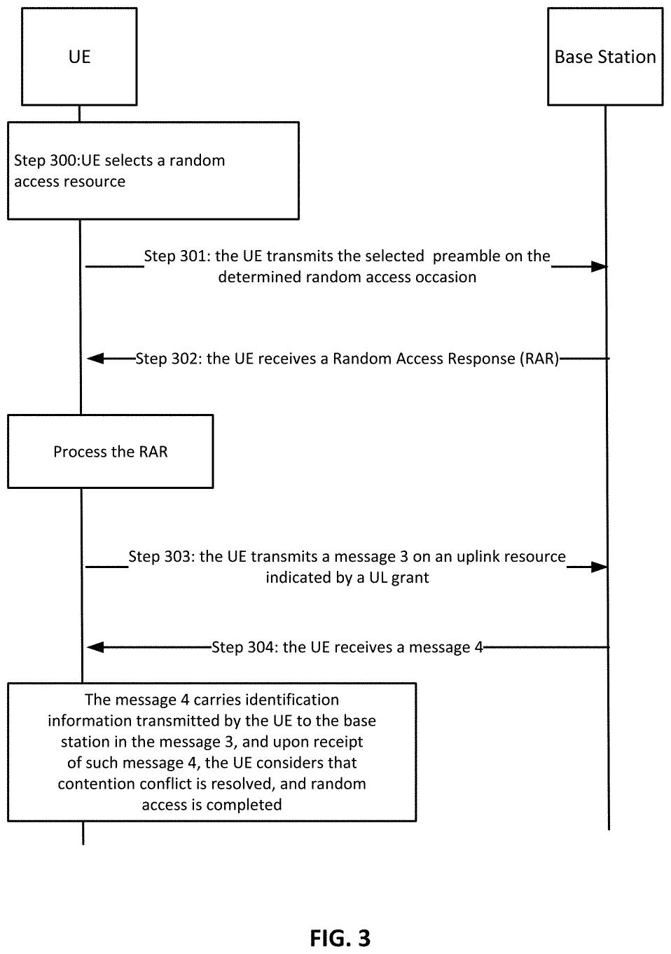

Firstly, a four-step random access procedure in the prior art will be described below on the basis of FIG. 3. FIG. 3 is a detailed sequence diagram illustrating a four-step random access procedure. As shown in FIG. 3, the 4-step random access procedure executed by UE generally includes the following steps.

Step 300: UE selects a random access resource used for random access. In this step,
the UE selects a preamble for transmission, and sets an index value corresponding to the selected preamble to be the value of a parameter PREAMBLE_INDEX; and
the next PRACH occasion available for transmission is determined from a plurality of PRACH occasions.

Step 301: the UE transmits the selected preamble on the determined PRACH occasion.

Step 302: the UE receives a Random Access Response (RAR) transmitted from a base station side.

If this RAR carries the index value corresponding to the preamble transmitted by the UE in step 301, then the UE can determine that the RAR is transmitted to the UE. A UL grant is carried in such RAR. This UL grant indicates a PUSCH resource used for transmitting a message 3.

After receiving the above RAR, the UE processes the UL grant carried in the RAR, and indicates the same to a lower layer. If it is the first time that the UE has successfully received the above RAR, then the UE obtains, from a multiplexing and assembly entity, a MAC PDU used for transmission, and stores the same in a message 3 buffer (MSG 3 buffer).

Step 303: the UE transmits the message 3 on the PUSCH resource indicated by the UL grant.

The UE carries, in this message 3, identification information used for contention conflict resolution.

Step 304: the UE receives a message 4 transmitted from the base station side.

If the message 4 carries the identification information carried by the UE in the message 3, then the UE considers that contention conflict is resolved, and the random access procedure is successfully completed.

In the above random access procedure, the UE executes steps 301-304 to perform message transmission, and therefore the random access procedure is referred to as a “four-step random access” (4-step RA) procedure.

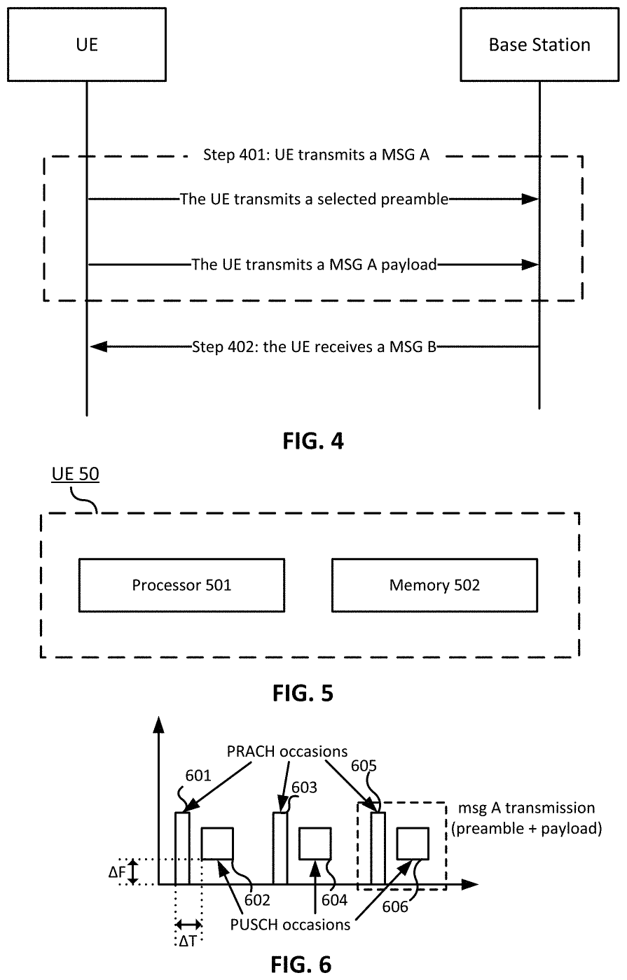

In order to reduce the time required for random access, a “two-step random access” (2-step RA) procedure is currently under discussion. The “two-step random access procedure” according to the present invention will be described in detail with regards to FIG. 4. FIG. 4 is a detailed sequence diagram illustrating a two-step random access procedure according to the present invention. The “two-step random access procedure” in the present invention generally includes the following steps.

Step 401: UE transmits a message A to a base station.

The message A includes a preamble and a message A payload.

The preamble is transmitted on a PRACH, and the message A payload is transmitted on a PUSCH. The message A payload is packaged into a MAC PDU, and is transmitted on the PUSCH. The message A payload can carry an RRC message such as an RRC connection establishment request message, and can also carry a user data packet.

Step 402: the UE receives a message B transmitted by the base station.

The message B carries information used for contention conflict resolution.

In chronological order, the UE first transmits the MSG A, the transmission including transmitting the preamble and transmitting the message A payload, and then the UE receives the message B transmitted by the base station. The message B is response information to the MSG A transmitted from a network side/the base station to the UE.

In addition, when the UE determines a transmission occasion available to the message A, the UE obtains, from the multiplexing and assembly entity, the MAC PDU used for transmission, and stores the obtained MAC PDU in a buffer.

Since the message A includes the preamble transmitted on the PRACH and message A payload information transmitted on the PUSCH, the above transmission occasion available to the message A includes, for example, the following: the UE determines a PUSCH occasion available for transmitting the message A payload; or the UE determines the next available PRACH occasion, wherein the PRACH occasion is used for transmitting the above preamble; or the UE selects one of the preambles, and the selected preamble is used for a current random access procedure; or the preamble selected by the UE is associated with the PUSCH or the PUSCH occasion.

FIG. 5 is a block diagram illustrating the user equipment (UE) according to the present invention. As shown in FIG. 5, the user equipment (UE) 50 includes a processor 501 and a memory 502. The processor 501 may include, for example, a microprocessor, a microcontroller, an embedded processor, etc. The memory 502 may include, for example, a volatile memory (such as a Random Access Memory (RAM)), a Hard Disk Drive (HDD), a non-volatile memory (such as a flash memory), or other memory. The memory 502 stores program instructions. When run by the processor 501, the instructions can execute the random access method described in detail in the present invention.

Specific embodiments according to the present invention will be described in detail below. In addition, as described above, the examples and embodiments in the present disclosure are illustrative descriptions for easy understanding of the present invention, and are not intended to limit the present invention.

### Embodiment 1

During a 2-step random access procedure executed by UE, in order to transmit a message A, the UE firstly needs to determine an occasion for transmitting the message A.

When the UE determines/selects an occasion available for transmitting the message A, the UE obtains, from a multiplexing and assembly entity, a MAC PDU used for transmission, and stores the same in a buffer. The buffer may be a message 3 buffer in the prior art, may also be a new buffer different from the message 3 buffer, and may be referred to as a MSG A buffer or a MSG A payload buffer.

Optionally, only if the occasion is the first/new transmission occasion for the message A determined by the UE in this random access procedure, or only if this determined occasion is used for the first/new transmission of the MSG A, then does the UE execute this step in which the UE obtains, from a multiplexing and assembly entity, a MAC PDU used for transmission, and stores the same in a buffer.

In addition, optionally, if the transmission of the MSG A payload (or the MSG A) is unrelated to a common control channel, or if the transmission of the MSG A payload (or the MSG A) is not performed for a logical channel having a logical channel type of a Common Control Channel (CCCH), then the UE instructs the multiplexing and assembly entity to include a C-RNTI MAC CE in the next transmission. Here, the C-RNTI MAC CE is a MAC CE having a value being a C-RNTI of the UE.

Optionally, when the UE determines an occasion available for transmitting the message A, the UE can consider a PUSCH occasion included in the occasion to be a UL grant, process this UL grant, and optionally indicate the same to a lower layer.

The message A includes a preamble and message A payload information. The preamble is transmitted on a PRACH, and the message A payload information is transmitted on a PUSCH. Therefore, the “determining a transmission occasion for the message A” may be determining a PUSCH occasion available for transmitting the message A payload information.

When the UE determines/selects a PUSCH occasion available for transmitting the message A payload information, the UE obtains, from a multiplexing and assembly entity, a MAC PDU used for transmission, and stores the same in a buffer. The buffer may be a message 3 buffer in the prior art, may also be a new buffer different from the message 3 buffer, and may be referred to as a MSG A buffer or a MSG A payload buffer.

Optionally, only if the occasion is the first/new PUSCH occasion determined by the UE in this random access procedure, or only if this determined PUSCH occasion is used for the first/new transmission of the MSG A payload (MSG A), then does the UE execute this step in which the UE obtains, from a multiplexing and assembly entity, a MAC PDU used for transmission, and stores the same in a buffer.

In addition, optionally, if the transmission of the MSG A payload (or the MSG A) is unrelated to a common control channel, or if the transmission of the MSG A payload (or the MSG A) is not performed for a logical channel having a logical channel type of a Common Control Channel (CCCH), then the UE instructs the multiplexing and assembly entity to include a C-RNTI MAC CE in the next transmission. Here, the C-RNTI MAC CE is a MAC CE having a value being a C-RNTI of the UE.

Optionally, when the UE determines a PUSCH occasion available for transmission, the UE can consider the PUSCH occasion to be a UL grant, process this UL grant, and optionally indicate the same to a lower layer.

In the above procedure, “the UE determines/selects a PUSCH occasion available for transmission” may specifically be, for example, as in embodiment 2 described below, that the UE determines a PUSCH occasion on the basis of an available PRACH occasion selected by the UE, or may also be, as in embodiment 3 described below, that the UE determines a PUSCH occasion on the basis of a preamble selected by the UE, or may be that the UE determines a PUSCH occasion on the basis of a combination of the selected PRACH occasion and the selected preamble.

### Embodiment 2

FIG. 6 is a diagram illustrating a correspondence between a PRACH occasion (e.g., 601, 603, or 605) and a PUSCH occasion (e.g., 602, 604, or 606) according to the present invention. In embodiment 2, the following situation is considered, specifically as shown in FIG. 6, a one-to-one correspondence between PRACH occasions (e.g., 601, 603, and 605) and PUSCH occasions (e.g., 602, 604, and 606) exists. Here, the PRACH occasion refers to a PRACH occasion used for transmitting a preamble of a message A, and the PUSCH occasion refers to a PUSCH occasion used for transmitting message A payload information.

The UE can obtain this correspondence according to pre-configured information. For example, a base station/network side is configured with time and frequency domain information of a PRACH resource in system information. According to this information, the UE can determine each PRACH occasion (e.g., 601, 603, and 605). In addition, the base station/network side is further configured with a frequency offset and/or a time offset of each PUSCH occasion (e.g., 602, 604, or 606) relative to a PRACH occasion (e.g., 601, 603, or 605) corresponding thereto, and can notify the UE of the same by means of broadcasting. Therefore, when the UE determines the next PRACH occasion (e.g., 601, 603, or 605) available for transmission, the UE can determine the next PUSCH occasion (e.g., 602, 604, or 606) available for transmission according to the time and frequency information of the PRACH occasion (e.g., 601, 603, or 605) in combination with the pre-configured frequency offset and time offset. In some implementations, the PRACH occasions 601, 603, and 605 may correspond to/associate with the PUSCH occasions 602, 604, and 606, respectively.

Therefore, on the basis of the above situation considered in embodiment 2, changes or adjustments can be made to embodiment 1 so as to obtain the following implementation manner

When the UE determines the next available PRACH occasion (e.g., 601, 603, or 605), the PRACH occasion (e.g., 601, 603, or 605) being used for transmitting the preamble in the message A, the UE obtains, from a multiplexing and assembly entity, a MAC PDU used for transmission, and stores the same in a buffer.

The buffer may be a message 3 buffer in the prior art, may also be a new buffer different from the message 3 buffer, and may be referred to as a MSG A buffer or a MSG A payload buffer.

Optionally, only if the PRACH occasion (e.g., 601, 603, or 605) is the first/new PRACH occasion determined by the UE in this random access procedure, or only if a PUSCH occasion (e.g., 602, 604, or 606) associated with the determined PRACH occasion (e.g., 601, 603, or 605) is used for the first/new transmission of the MSG A payload (MSG A), then does the UE execute this step in which the UE obtains, from a multiplexing and assembly entity, a MAC PDU used for transmission, and stores the same in a buffer.

Optionally, if the transmission of the MSG A payload (or the MSG A) is unrelated to a common control channel, or if the transmission of the MSG A payload (or the MSG A) is not performed for a logical channel having a logical channel type of a Common Control Channel (CCCH), then the UE instructs the multiplexing and assembly entity to include a C-RNTI MAC CE in the next transmission.

Optionally, when the UE determines the next available PRACH occasion (e.g., 601, 603, or 605), the UE can consider the PUSCH occasion (e.g., 602, 604, or 606) associated with the PRACH occasion (e.g., 601, 603, or 605) to be a UL grant, process this UL grant, and optionally indicate the same to a lower layer (e.g., PHY layer). As such, the lower layer (e.g., PHY layer) may transmit the MSG A payload (or the MSG A) on the PUSCH occasion (e.g., 602, 604, or 606).

In some implementations, the PRACH occasions 601, 603, and 605 may correspond to/associate with the PUSCH occasions 602, 604, and 606, respectively. If the UE determines the next available PRACH occasion to be 605, the UE may consider 606 to be a UL grant and process this UL grant. The UE may optionally indicate the same to a lower layer (e.g., PHY layer). Subsequently, the lower layer (e.g., PHY layer) may transmit the MSG A payload (or the MSG A) on the PUSCH occasion 606.

### Embodiment 3

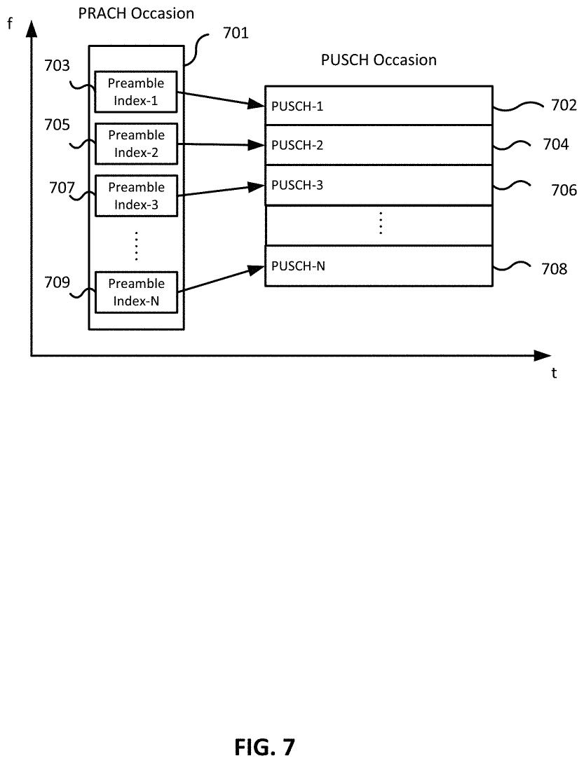

In embodiment 3, the following situation is further considered, that is, as shown in FIG. 7, in addition to that a PUSCH occasion corresponds to a PRACH occasion (such as the above situation in embodiment 2), a one-to-one correspondence between PUSCH occasions and preambles further exists. FIG. 7 is a diagram illustrating a correspondence between a PUSCH occasion (e.g., 702, 704, 706, or 708) and a preamble (e.g., 703, 705, 707, or 709) according to the present invention.

That is, one PRACH occasion (e.g., 701) corresponds to a plurality of PUSCH occasions (e.g., 702, 704, 706, and 708) (or a PUSCH occasion group), and the PUSCH occasions (e.g., 702, 704, 706, and 708) respectively correspond to the preambles (e.g., 703, 705, 707, and 709) in a one-to-one manner. For example, in FIG. 7, preamble with an index of 1 (e.g., 703) may correspond to PUSCH-1 (e.g., 702), preamble with an index of 2 (e.g., 705) may correspond to PUSCH-2 (e.g., 704), preamble with an index of 3 (e.g., 707) may be correspond to PUSCH-3 (e.g., 706), preamble with an index of N (e.g., 709) may correspond to PUSCH-N (e.g., 708). Here, the PUSCH occasion group (e.g., including the PUSCH occasions 702, 704, 706, and 708) corresponding to one PRACH occasion (e.g., 701) is referred to as a PUSCH resource.

In this case, the UE can use the method described in the embodiment to first determine an available PUSCH occasion group according to a determined next available PRACH occasion and then determine, according to a selected preamble, a PUSCH occasion in the available PUSCH occasion group that can be used by the UE to transmit a MSG A payload.

Specifically, the PUSCH occasions in the PUSCH occasion group may be numbered, or the PUSCH occasions may be sorted in an ascending order (from low to high or from small to large) and numbered according to a starting position of time or frequency of a PUSCH resource in which each PUSCH occasion is located.

In addition, all of preambles available for determining the PUSCH occasion group and transmitted on the PRACH occasions are arranged in an ascending order according to respective values of index IDs.

Each preamble index may correspond to a corresponding PUSCH occasion group number, so that the UE can determine, by determining a preamble, a PUSCH occasion available for transmitting the MSG A payload.

On the basis of the above situation considered in embodiment 3, changes or adjustments can be made to embodiment 1 so as to obtain the following possible implementation manner

When the UE selects a preamble, particularly, if this preamble is used for a 2-step RA procedure, or if the preamble selected by the UE corresponds to/is associated with a PUSCH (or is associated with a PUSCH occasion), then the UE obtains, from a multiplexing and assembly entity, a MAC PDU used for transmission, and stores the same in a buffer.

The buffer may be a message 3 buffer in the prior art, may also be a new buffer different from the message 3 buffer, and may be referred to as a MSG A buffer or a MSG A payload buffer.

Optionally, only if it is the first time that the UE selects a preamble in this random access procedure, or only if a PUSCH occasion associated with the selected preamble is used for the first/new transmission of the MSG A payload (MSG A), then does the UE execute this step in which the UE obtains, from a multiplexing and assembly entity, a MAC PDU used for transmission, and stores the same in a buffer.

Optionally, if the transmission of the MSG A payload (or the MSG A) is unrelated to a common control channel, or if the transmission of the MSG A payload (or the MSG A) is not performed for a logical channel having a logical channel type of a Common Control Channel (CCCH), then the UE instructs the multiplexing and assembly entity to include a C-RNTI MAC CE in the next transmission.

In addition, optionally, when the UE selects a preamble, specifically if this preamble is used for a 2-step RA procedure, or if the preamble selected by the UE corresponds to/is associated with a PUSCH (or is associated with a PUSCH occasion), then the UE can consider the PUSCH occasion associated with the preamble to be a UL grant, process this UL grant, and optionally indicate the same to a lower layer.

Further, another implementation of the above solution may be performed after the UE instructs a physical layer to transmit the preamble on the selected PRACH occasion.

For example, the UE instructs the physical layer to transmit the preamble on the selected PRACH occasion.

If the preamble transmitted by the UE is used for a 2-step RA procedure, or if the transmitted preamble corresponds to/is associated with a PUSCH (or is associated with a PUSCH occasion), or if a PRACH occasion used for transmitting the preamble corresponds to/is associated with a PUSCH (or is associated with a PUSCH occasion), then the UE obtains, from a multiplexing and assembly entity, a MAC PDU used for transmission, and stores the same in a buffer.

The buffer may be a message 3 buffer in the prior art, may also be a new buffer different from the message 3 buffer, and may be referred to as a MSG A buffer or a MSG A payload buffer.

Optionally, only if it is the first time that the UE transmits a preamble in this random access procedure, or only if a PUSCH occasion associated with the transmitted preamble or a PUSCH occasion associated with this PRACH occasion used for transmitting the preamble is used for the first/new transmission of the MSG A payload (MSG A), then does the UE execute this step in which the UE obtains, from a multiplexing and assembly entity, a MAC PDU used for transmission, and stores the same in a buffer.

Optionally, if the transmission of the MSG A payload (or the MSG A) is unrelated to a common control channel, or if the transmission of the MSG A payload (or the MSG A) is not performed for a logical channel having a logical channel type of a Common Control Channel (CCCH), then the UE instructs the multiplexing and assembly entity to include a C-RNTI MAC CE in the next transmission.

In addition, optionally, if the preamble transmitted by the UE is used for a 2-step RA procedure, or if the transmitted preamble corresponds to/is associated with a PUSCH (or is associated with a PUSCH occasion), or if the PRACH occasion used for transmitting the preamble corresponds to/is associated with a PUSCH (or is associated with a PUSCH occasion), then the UE can consider the PUSCH occasion associated with the preamble to be a UL grant, process this UL grant, and optionally indicate the same to a lower layer.

### Embodiment 4

Embodiment 4 according to the present invention will be described below.

In embodiments 1-3, if the UE obtains, from a multiplexing and assembly entity, a MAC PDU used for transmission, and stores the same in a MSG 3 buffer:

in this case, when the UE receives a UL grant, if this UL grant is used for 2-step RA, or if this UL grant is used for transmission of a MSG A payload, or if this UL grant is related to 2-step RA, then the UE can obtain the MAC PDU from the MSG 3 buffer, and transmit the same.

When the UE receives a UL grant in an RAR, the UE obtains the MAC PDU from the MSG 3 buffer, and transmits the same.

After obtaining the MAC PDU used for transmission, the UE delivers the MAC PDU and the UL grant to a Hybrid Automatic Repeat Request (HARQ) process corresponding thereto, and instructs the HARQ process to initiate a new transmission of a transport block. This transport block carries the foregoing MAC PDU. Correspondingly, upon receipt of a request for a new transmission of a certain transport block, the HARQ process stores a MAC PDU corresponding to the transport block in an HARQ buffer, this HARQ buffer being corresponding to/belonging to the HARQ process; and stores a received UL grant. Then the HARQ process instructs the physical layer/lower layer to transmit the transport block on the stored UL grant.

Alternatively, in embodiments 1-3, if the UE obtains, from a multiplexing and assembly entity, a MAC PDU used for transmission, and stores the same in a buffer used as a non-MSG 3 buffer or referred to as a MSG A buffer:

in this case, when the UE receives a UL grant, if this UL grant is used for 2-step RA, or if this UL grant is used for transmission of a MSG A payload, or if this UL grant is related to 2-step RA, then the UE can obtain the MAC PDU from the MSG A buffer, and transmit the same.

When the UE receives a UL grant in an RAR, the UE obtains the MAC PDU from the MSG 3 buffer, and transmits the same.

Particularly, after obtaining the MAC PDU used for transmission, the UE delivers the MAC PDU and the UL grant to a HARQ process corresponding thereto, and instructs the HARQ process to initiate a new transmission of a transport block. This transport block carries the foregoing MAC PDU. Correspondingly, upon receipt of a request for a new transmission of a certain transport block, the HARQ process stores a MAC PDU corresponding to the transport block in an HARQ buffer, this HARQ buffer being corresponding to/belonging to the HARQ process; and stores a received UL grant. Then the HARQ process instructs the physical layer/lower layer to transmit the transport block on the stored UL grant.

The program running in the device according to the present invention may be a program that enables a computer to implement the functions of the embodiments of the present invention by controlling a central processing unit (CPU). The program or information processed by the program may be temporarily stored in a volatile memory (such as a Random Access Memory (RAM)), a Hard Disk Drive (HDD), a non-volatile memory (such as a flash memory), or another memory system.

Programs for performing the functions of the various embodiments of the present invention may be recorded in a computer-readable recording medium. Corresponding functions may be fulfilled by causing a computer system to read the programs recorded in the recording medium and execute these programs. The so-called “computer system” here may be a computer system embedded in the device, and may include an operating system or hardware (such as peripheral devices). The “computer-readable recording medium” may be a semiconductor recording medium, an optical recording medium, a magnetic recording medium, a recording medium storing a program dynamically for a short time, or any other recording medium readable by a computer.

Various features or functional modules of the devices used in the above embodiments may be implemented or executed by circuits (such as single-chip or multi-chip integrated circuits). Circuits designed to execute the functions described in this specification may include a general-purpose processor, a Digital Signal Processor (DSP), an Application-Specific Integrated Circuit (ASIC), a Field Programmable Gate Array (FPGA), or another programmable logic device, a discrete gate or transistor logic, a discrete hardware component, or any combination of the above devices. The general-purpose processor may be a microprocessor, or any existing processor, controller, microcontroller, or state machine. The above circuit may be a digital circuit or an analog circuit. In the case of new integrated circuit technologies that replace existing integrated circuits because of advancements in the semiconductor technologies, one or a plurality of embodiments of the present invention may also be implemented using these new integrated circuit technologies.

In addition, the present invention is not limited to the above embodiments. Various examples of the embodiments have been described; however, the present invention is not limited thereto. Fixed or non-mobile electronic devices mounted indoors or outdoors may be used as terminal devices or communication devices, such as Audio Video (AV) devices, kitchen devices, cleaning devices, air conditioners, office devices, vending machines, and other household appliances.

As described above, the embodiments of the present invention have been described in detail with reference to the accompanying drawings. However, the specific structure is not limited to the above embodiments, and the present invention also includes any design changes that do not deviate from the gist of the present invention. In addition, various modifications may be made to the present invention within the scope of the claims, and embodiments obtained by appropriately combining the technical means disclosed in different embodiments are also included in the technical scope of the present invention. In addition, the components having the same effects described in the above embodiments may be substituted for each other.

1. A random access method performed by a user equipment, the random access method comprising:
transmitting a message A to a base station, wherein the message A comprises a preamble and a message A payload; and
after completing transmission of the message A, receiving a message B from the base station as a response message to the message A, wherein:
the preamble is transmitted on a Physical Random Access Channel (PRACH);
the message A payload is included in a Medium Access Control (MAC) Protocol Data Unit (PDU), and is transmitted on a Physical Uplink Shared Channel (PUSCH); and
obtaining, from a multiplexing and assembly entity, the MAC PDU used for transmission, and storing the MAC PDU in a buffer when determining that a transmission occasion is available for the message A.

2. The random access method according to claim 1, wherein determining that the transmission occasion is available for the message A comprises one of:
determining that a Physical Uplink Shared Channel (PUSCH) occasion is available for transmitting the message A payload;
determining that a next available PRACH occasion is used for transmitting the preamble; and
selecting a preamble that is used for a current random access procedure, and the selected preamble is associated with the PUSCH occasion.

3. The random access method according to claim 2, wherein obtaining, from the multiplexing and assembly entity, the MAC PDU used for transmission comprises obtaining the MAC PDU if:
the UE determines the PUSCH occasion is available for transmitting the message A; and
the determined PUSCH occasion is a first PUSCH occasion determined by the UE in the current random access procedure, or the determined PUSCH occasion is used for a new transmission of the message A payload.

4. The random access method according to claim 2, wherein obtaining, from the multiplexing and assembly entity, the MAC PDU used for transmission comprises obtaining the MAC PDU if:
the UE determines the next available PRACH occasion; and
the determined next available PRACH occasion is a first PRACH occasion determined by the UE in the current random access procedure, or a PUSCH occasion associated with the determined next available PRACH occasion is used for a new transmission of the message A payload.

5. The random access method according to claim 2, wherein obtaining, from the multiplexing and assembly entity, the MAC PDU used for transmission comprises obtaining the MAC PDU if:
the UE selects the preamble used for the current random access procedure or the preamble associated with the PUSCH or the PUSCH occasion; and
the selected preamble is a first preamble selected in the current random access procedure, or a PUSCH occasion associated with the selected preamble is used for a new transmission of the message A payload.

6. The random access method according to claim 2, wherein obtaining, from the multiplexing and assembly entity, the MAC PDU used for transmission comprises obtaining the MAC PDU if:
the UE instructs a physical layer to transmit the selected preamble on the next available PRACH occasion; and
the transmitted preamble is used for the current random access procedure, or the transmitted preamble is associated with a PUSCH, or the next available PRACH occasion is associated with a PUSCH.

7. The random access method according to claim 2, further comprising:
using the determined PUSCH occasion that is available for the transmission as an uplink (UL) grant, and processing the UL grant if the UE determines the PUSCH occasion;
using a PUSCH occasion associated with the next available PRACH occasion as an UL grant, and processing the UL grant if the UE determines the next available PRACH occasion; and
using the PUSCH occasion associated with the preamble used for the current random access procedure as an UL grant, and processing the UL grant if the UE selects the preamble used for the current random access procedure or the preamble associated with the PUSCH or the PUSCH occasion and the selected preamble is used for the current random access procedure, or the selected preamble is associated with the PUSCH or the PUSCH occasion.

8. The random access method according to claim 1, further comprising instructing the multiplexing and assembly entity to include a Cell Radio Network Temporary Identifier (C-RNTI) MAC Control Element (CE) in a next transmission if the transmission of the message A payload or the transmission of the message A is unrelated to a Common Control Channel (CCCH), or is not performed for a logical channel having a logical channel type of CCCH.

9. The random access method according to claim 1, further comprising:
storing the MAC PDU in a message 3 buffer or in a message A buffer;
obtaining the MAC PDU from the buffer in which the MAC PDU is stored, and transmitting the obtained MAC PDU when the UE receives an uplink (UL) grant, if:
the UL grant is used for the current random access procedure, or the UL grant is used for the transmission of the message A payload, or the UL grant is related to the current random access procedure,
or the UL grant is received in a Random Access Response (RAR).

10. A User equipment (UE), comprising:
a processor; and
a memory, storing instructions,
the processor configured to execute the instructions to:
transmit a message A to a base station, wherein the message A comprises a preamble and a message A payload; and
after completing transmission of the message A, receive a message B from the base station as a response message to the message A, wherein:
the preamble is transmitted on a Physical Random Access Channel (PRACH);
the message A payload is included in a Medium Access Control (MAC) Protocol Data Unit (PDU), and is transmitted on a Physical Uplink Shared Channel (PUSCH); and
obtain, from a multiplexing and assembly entity, the MAC PDU used for transmission, and store the MAC PDU in a buffer when determining that a transmission occasion is available for the message A.

11. The UE of claim 10, wherein the processor is further configured to execute the instructions to:
determine that the transmission occasion is available for the message A based on one of:
determining that a Physical Uplink Shared Channel (PUSCH) occasion is available for transmitting the message A payload;
determining that a next available PRACH occasion is used for transmitting the preamble; and
selecting a preamble that is used for a current random access procedure, and the selected preamble is associated with the PUSCH occasion.

12. The UE of claim 11, wherein the processor is further configured to execute the instructions to:
obtain, from the multiplexing and assembly entity, the MAC PDU used for transmission if:
the UE determines the PUSCH occasion is available for transmitting the message A; and
the determined PUSCH occasion is a first PUSCH occasion determined by the UE in the current random access procedure, or the determined PUSCH occasion is used for a new transmission of the message A payload.

13. The UE of claim 11, wherein the processor is further configured to execute the instructions to:
obtain, from the multiplexing and assembly entity, the MAC PDU used for transmission if:
the UE determines the next available PRACH occasion; and
the determined next available PRACH occasion is a first PRACH occasion determined by the UE in the current random access procedure, or a PUSCH occasion associated with the determined next available PRACH occasion is used for a new transmission of the message A payload.

14. The UE of claim 11, wherein the processor is further configured to execute the instructions to:
obtain, from the multiplexing and assembly entity, the MAC PDU used for transmission if:
the UE selects the preamble used for the current random access procedure or the preamble associated with the PUSCH or the PUSCH occasion; and
the selected preamble is a first preamble selected in the current random access procedure, or a PUSCH occasion associated with the selected preamble is used for a new transmission of the message A payload.

15. The UE of claim 11, wherein the processor is further configured to execute the instructions to:
obtain, from the multiplexing and assembly entity, the MAC PDU used for transmission if:
the UE instructs a physical layer to transmit the selected preamble on the next available PRACH occasion; and
the transmitted preamble is used for the current random access procedure, or the transmitted preamble is associated with a PUSCH, or the next available PRACH occasion is associated with a PUSCH.

16. The UE of claim 11, wherein the processor is further configured to execute the instructions to:
use the determined PUSCH occasion that is available for the transmission as an uplink (UL) grant, and processing the UL grant if the UE determines the PUSCH occasion;
use a PUSCH occasion associated with the next available PRACH occasion as an UL grant, and processing the UL grant if the UE determines the next available PRACH occasion; and
use the PUSCH occasion associated with the preamble used for the current random access procedure as an UL grant, and process the UL grant if the UE selects the preamble used for the current random access procedure or the preamble associated with the PUSCH or the PUSCH occasion and the selected preamble is used for the current random access procedure, or the selected preamble is associated with the PUSCH or the PUSCH occasion.

17. The UE of claim 10, wherein the processor is further configured to execute the instructions to:
instruct the multiplexing and assembly entity to include a Cell Radio Network Temporary Identifier (C-RNTI) MAC Control Element (CE) in a next transmission if the transmission of the message A payload or the transmission of the message A is unrelated to a Common Control Channel (CCCH), or is not performed for a logical channel having a logical channel type of CCCH.

18. The UE of claim 10, wherein the processor is further configured to execute the instructions to:
store the MAC PDU in a message 3 buffer or in a message A buffer;
obtain the MAC PDU from the buffer in which the MAC PDU is stored; and
transmit the obtained MAC PDU when the UE receives an uplink (UL) grant, if the UL grant is used for the current random access procedure, or the UL grant is used for the transmission of the message A payload, or the UL grant is related to the current random access procedure, or the UL grant is received in a Random Access Response (RAR).
